(19) United States
(12) Patent Application Publication
(10) Pub. No.: US 2026/0089799 A1
(43) Pub. Date: Mar. 26, 2026

(54) METHODS AND APPARATUSES FOR A PDCCH MONITORING ENHANCEMENT MECHANISM FOR XR TRAFFIC

(71) Applicant: Lenovo (Beijing) Limited, Beijing (CN)

(72) Inventors: Xiaoying XU, Beijing (CN); Mingzeng DAI, Shanghai (CN); Congchi ZHANG, Shanghai (CN)

(21) Appl. No.: 19/110,791

(22) PCT Filed: Sep. 29, 2022
(86) PCT No.: PCT/CN2022/122914

§ 371 Date: Mar. 11, 2025

(51) Int. Cl. H04W 76/28; H04W 52/02; H04W 72/23

(52) U.S. Cl. CPC H04W 76/28; H04W 52/0235; H04W 72/23

(57) ABSTRACT

Embodiments of the present application relate to methods and apparatuses for a physical downlink control channel (PDCCH) monitoring enhancement mechanism for power saving for extended reality (XR) traffic. According to an embodiment of the present application, a network node includes a transceiver and a processor coupled to the transceiver, and the processor is configured to transmit configuration information via the transceiver to a user equipment (UE) for one or more serving cells in one or more DRX groups, wherein the configuration information includes at least one of configuration information regarding a search space set group (SSSG), configuration information regarding another SSSG, one or more groups of configuration information regarding a discontinuous reception (DRX), or configuration information of SSSG applying associated with DRX operation of the UE, wherein the configuration information of SSSG applying is used to enable the UE to start monitoring a physical downlink control channel (PDCCH) transmission according to search space sets within the SSSG at a time point for the one or more serving cells within the one or more DRX groups.

### TECHNICAL FIELD

Embodiments of the present application generally relate to wireless communication technology, especially to methods and apparatuses for a physical downlink control channel (PDCCH) monitoring enhancement mechanism for power saving for extended reality (XR) traffic.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, power saving of a XR device is one of key topics. Currently, details regarding a PDCCH monitoring enhancement mechanism for power saving for XR traffic have not been discussed yet.

### SUMMARY

Some embodiments of the present application provide a network node. The network node includes a transceiver and a processor coupled to the transceiver; and the processor is configured to transmit first configuration information via the transceiver to a user equipment (UE) for one or more serving cells in one or more DRX groups, wherein the first configuration information includes at least one of configuration information regarding a first search space set group (SSSG), configuration information regarding a second SSSG, one or more groups of configuration information regarding discontinuous reception (DRX), or configuration information of SSSG applying associated with DRX operation of the UE, wherein the configuration information of SSSG applying is used to enable the UE to start monitoring a physical downlink control channel (PDCCH) transmission according to search space sets within the first SSSG at a first time point for the one or more serving cells within the one or more DRX groups.

In some embodiments, the first configuration information is transmitted in a radio resource control (RRC) message.

In some embodiments, each serving cell within the one or more serving cells is uniquely assigned to one DRX group of the one or more DRX groups, and wherein multiple DRX parameters of each DRX group within the one or more DRX groups include: one or more DRX parameters that are commonly configured to the one or more DRX groups, and one or more DRX parameters that are separately configured for the each DRX group.

In some embodiments, each serving cell within the one or more serving cells is assigned to two or more DRX groups within the one or more DRX groups, and wherein one or more DRX parameters are separately configured for each DRX group within the two or more DRX groups.

In some embodiments, the first configuration information includes information related to a cell group bundled for SSSG switching, and wherein the serving cells for the SSSG applying in one DRX group within the one or more DRX groups only belong to one cell group bundled for SSSG switching.

In some embodiments, the configuration information of SSSG applying includes at least one of identity information related to the first SSSG; identity information related to the second SSSG; information for indicating whether to enable a SSSG applying function of the UE; identity information related to a search space set associated with on-duration of a DRX cycle; a timer related to the SSSG applying function of the UE; a delay value applied by the UE during the SSSG applying; or one or more time offsets related to on-duration of the DRX cycle.

In some embodiments, the configuration information of SSSG applying is configured per serving cell, per cell group, per DRX group, or per bandwidth part (BWP).

In some embodiments, the first time point is at least one of: a start slot of on-duration of a DRX cycle; a slot after a slot where the UE is in DRX active time only due to a DRX on-duration timer being running; a slot after a slot where a DRX inactivity timer expires; or a slot after a last slot where the UE is in the DRX active time.

Some embodiments of the present application provide a user equipment (UE). The UE includes a transceiver and a processor coupled to the transceiver; and the processor is configured to: receive first configuration information via the transceiver from a network node, wherein the first configuration information includes at least one of: configuration information regarding a first search space set group (SSSG), configuration information regarding a second SSSG, one or more groups of configuration information regarding a discontinuous reception (DRX) for one or more serving cells in one or more DRX groups, or configuration information of SSSG applying associated with DRX operation of the UE; and start monitoring a physical downlink control channel (PDCCH) transmission according to search space sets within the first SSSG at the first time point for the one or more serving cells within the one or more DRX groups based on the configuration information of SSSG applying.

In some embodiments, the first configuration information is received in a radio resource control (RRC) message.

In some embodiments, the configuration information of SSSG applying includes at least one of: identity information related to the first SSSG; identity information related to the second SSSG; information for indicating whether to enable a SSSG applying function of the UE; identity information related to a search space set associated with on-duration of a DRX cycle; a timer related to the SSSG applying function of the UE; a delay value applied by the UE during the SSSG applying; or one or more time offsets related to on-duration of the DRX cycle.

In some embodiments, the configuration information of SSSG applying is configured per serving cell, per cell group, per DRX group, or per bandwidth part (BWP).

In some embodiments, the first time point is at least one of: a start slot of on-duration of a DRX cycle; a slot after a slot where the UE is in DRX active time only due to a DRX on-duration timer being running; a slot after a slot where a DRX inactivity timer expires; or a slot after a last slot where the UE is in the DRX active time.

In some embodiments, the processor of the UE is configured to evaluate whether at least one SSSG applying condition based on the configuration information of SSSG applying is fulfilled at the first time point related to the DRX operation of the UE, and wherein monitoring the PDCCH transmission is started according to the search space sets within the first SSSG at the first time point in response to fulfillment of the at least one SSSG applying condition at the first time point.

In some embodiments, the fulfillment of the at least one SSSG applying condition includes at least one of: the UE is in DRX active time for the one or more serving cells at a start slot of on-duration of a DRX cycle only due to a DRX on-duration timer being running; no reception of an indication for indicating the UE to start monitoring the PDCCH transmission according to the second SSSG on the one or more serving cells during a time period of a time offset before a start slot of on-duration of the DRX cycle or at/till a second time point with the time offset before the start slot of on-duration of the DRX cycle; no reception of downlink control information (DCI) scrambled by a radio network temporary identification (RNTI) on the one or more serving cells during the time period of the time offset before the start slot of on-duration of the DRX cycle or at/till the second time point; a medium access control (MAC) entity being not monitoring the PDCCH transmission on a search space for beam failure recovery of the one or more serving cells during the time period of the time offset before the start slot of on-duration of the DRX cycle or at the start slot of on-duration of the DRX cycle or at/till the second time point; at least one of multiple timers including a DRX inactivity timer, a random access (RA) contention resolution timer, a msgB response timer, DRX retransmission timer for downlink, and DRX retransmission timer for uplink of the one or more serving cells being not running during the time period of the time offset before the start slot of on-duration of the DRX cycle or at the start slot of on-duration of the DRX cycle or at/till the second time point; or the UE being in DRX inactive time for the one or more serving cells during the time period of the time offset before the start slot of on-duration of the DRX cycle or at/till the second time point.

In some embodiments, the fulfillment of the at least one SSSG applying condition includes at least one of: no DCI being detected at a slot where the UE is in DRX active time only due to a DRX on-duration timer being running, at/till a slot after a slot where the UE is in the DRX active time only due to the DRX on-duration timer being running, at a slot where a DRX inactivity timer expires, at/till a slot after a slot where the DRX inactivity timer expires, at a last slot where the UE is in the DRX active time, or at/till a slot after a last slot where the UE is in the DRX active time; no SR being sent or being pending at a slot where the UE is in DRX active time only due to the DRX on-duration timer being running, at/till a slot after a slot where the UE is in the DRX active time only due to the DRX on-duration timer being running, at a slot where the DRX inactivity timer expires, at/till a slot after a slot where the DRX inactivity timer expires, at a last slot where the UE is in the DRX active time, or at/till a slot after a last slot where the UE is in the DRX active time; reception of a PDCCH transmission indicating a new transmission at a slot where the UE is in the DRX active time only due to the DRX on-duration timer being running, at/till a slot after a slot where the UE is in the DRX active time only due to the DRX on-duration timer being running, after successful reception of a RA response, at a slot where the DRX inactivity timer expires, at/till a slot after a slot where the DRX inactivity timer expires, at a last slot where the UE is in the DRX active time, or at/till a slot after a last slot where the UE is in the DRX active time; or a medium access control (MAC) entity not monitoring the PDCCH transmission on a search space for beam failure recovery of the one or more serving cells at a slot where the UE is in the DRX active time only due to the DRX on-duration timer being running, at/till a slot after a slot where the UE is in the DRX active time only due to the DRX on-duration timer being running, at a slot where the DRX inactivity timer expires, at/till a slot after a slot where the DRX inactivity timer expires, at a last slot where the UE is in the DRX active time, or at/till a slot after a last slot where the UE is in the DRX active time.

In some embodiments, in response to fulfillment of the at least one SSSG applying condition at the first time point, the processor of the UE is configured to stop monitoring the PDCCH transmission in search space sets within the second SSSG.

In some embodiments, the processor of the UE is configured to: receive a search space group identity list; and reset to monitor the PDCCH transmission according to the first SSSG upon reception of at least one of the configuration information of SSSG applying or the search space group identity list.

In some embodiments, in response to starting monitoring the PDCCH transmission according to the search space sets within the first SSSG, the processor of the UE is configured to stop a search space switch timer in response to that the search space switch timer is running.

In some embodiments, the processor of the UE is configured to stop monitoring the PDCCH transmission in the search space sets within the first SSSG and start monitoring the PDCCH transmission according to search space sets within the second SSSG, in response to at least one of: reception of downlink control information (DCI), wherein the DCI indicates a new transmission or a retransmission for the UE; starting a random access (RA) response timer for monitoring a PDCCH transmission on a search space of the one or more serving cells; starting a DRX retransmission timer for downlink; starting a DRX retransmission timer for uplink; starting a RA contention resolution timer; starting a msgB response timer; or transmitting scheduling request (SR) on a physical uplink control channel (PUCCH) transmission.

In some embodiments, the processor of the UE is configured to determine a start slot of the search space sets in the first SSSG according to a start slot of on-duration of a DRX cycle for the one or more serving cells.

In some embodiments, to start monitoring the PDCCH transmission according to the search space sets in the first SSSG, the processor of the UE is configured to be bundled to start monitoring the PDCCH transmission at the first time point for all the one or more serving cells within the one or more DRX groups or for a subset within the one or more serving cells within the one or more DRX groups, and wherein the subset is configured with the configuration information of SSSG applying.

In some embodiments, in response to reception of both information related to a cell group bundled for SSSG switching and the configuration information of SSSG applying in one DRX group within the one or more DRX groups, the processor of the UE is configured to ignore information related to the cell group for SSSG switching including two or more serving cells with the configuration information of SSSG applying.

In some embodiments, each serving cell within the one or more serving cells is uniquely assigned to one DRX group of the one or more DRX groups, and wherein multiple DRX parameters of each DRX group within the one or more DRX groups include: one or more DRX parameters that are commonly configured to the one or more DRX groups, and one or more DRX parameters that are separately configured for the each DRX group.

In some embodiments, each serving cell within the one or more serving cells is assigned to two or more DRX groups within the one or more DRX groups, and wherein one or more DRX parameters are separately configured for each DRX group within the two or more DRX groups.

Some embodiments of the present application provide a method performed by a network node. The method includes: transmitting first configuration information to a user equipment (UE), wherein the first configuration information includes at least one of: configuration information regarding a first search space set group (SSSG), configuration information regarding a second SSSG, one or more groups of configuration information regarding a discontinuous reception (DRX), or configuration information of SSSG applying associated with DRX operation of the UE, wherein the configuration information of SSSG applying is used to enable the UE to start monitoring a physical downlink control channel (PDCCH) transmission according to search space sets within the first SSSG at a first time point for the one or more serving cells within the one or more DRX groups.

Some embodiments of the present application provide a method performed by a UE. The method includes: receiving first configuration information from a network node, wherein the first configuration information includes at least one of: configuration information regarding a first search space set group (SSSG), configuration information regarding a second SSSG, one or more groups of configuration information regarding a discontinuous reception (DRX) for one or more serving cells in one or more DRX groups, or configuration information of SSSG applying associated with DRX operation of the UE; and starting monitoring a physical downlink control channel (PDCCH) transmission according to search space sets within the first SSSG at the first time point for the one or more serving cells within the one or more DRX groups based on the configuration information of SSSG applying.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS)).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary diagram of applying SSSG in accordance with some embodiments of the present application.

FIG. 3 illustrates an exemplary flowchart of monitoring a PDCCH transmission in accordance with some embodiments of the present application.

FIG. 4 illustrates an exemplary diagram of applying SSSG in accordance with some embodiments of the present application.

FIG. 5 illustrates an exemplary diagram of applying SSSG in accordance with some embodiments of the present application.

FIG. 6 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

As specified in 3GPP TS 38.213, regarding search space set group (SSSG) switching and skipping of PDCCH monitoring, a UE can be provided a group index for a respective Type3-PDCCH CSS set or USS set by searchSpaceGroupIdList for PDCCH monitoring on a serving cell. A UE may determine a slot and a symbol in the slot to start or stop PDCCH monitoring according to search space sets for a serving cell that the UE is provided searchSpaceGroupIdList or, if cellGroupsForSwitchList is provided, for a set of serving cells, based on the smallest SCS configuration y among all configured DL BWPs in the serving cell or in the set of serving cells and, if any, in the serving cell where the UE receives a PDCCH and detects a corresponding DCI format 2_0 triggering the start or stop of PDCCH monitoring according to search space sets. When a UE is provided searchSpaceGroupIdList, the UE may reset PDCCH monitoring according to search space sets with group index 0 (i.e., SSSG 0), if provided by searchSpaceGroupIdList.

As specified in 3GPP TS 38.321, regarding discontinuous reception (DRX), the MAC entity of a UE may be configured by RRC with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. When using DRX operation, the MAC entity of the UE shall also monitor PDCCH according to requirements. When in RRC_CONNECTED, if DRX is configured, for all the activated Serving Cells, the MAC entity of the UE may monitor the PDCCH discontinuously using the DRX operation; otherwise, the MAC entity shall monitor the PDCCH.

In general, Serving Cells of the MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group may be: drx-onDurationTimer, and drx-InactivityTimer. The DRX parameters that are common to the DRX groups may be: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL. Regardless of whether the MAC entity is monitoring PDCCH or not on the Serving Cells in a DRX group, the MAC entity transmits HARQ feedback, aperiodic CSI on PUSCH, and aperiodic SRS defined in 3GPP TS 38.214 on the Serving Cells in the DRX group when such is expected. The MAC entity needs not to monitor the PDCCH if it is not a complete PDCCH occasion (e.g., the Active Time starts or ends in the middle of a PDCCH occasion).

Typically, XR, including AR and VR, as well as Cloud Gaming (CG), presents a new promising category of connected devices, applications, and services. As a potential working area of 3GPP Rel-18, power saving of XR device is one of key topics. Currently, there is the challenge that more power consumption due to large on-duration to adapt the downlink (DL) arrival jitter. DRX allows a UE to stop monitoring PDCCH during periods of time when there is no data activity, thereby saving power and without signalling overhead. However, due to a random arrival jitter range for DL XR traffic which is about [−4 ms, 4 ms], to avoid delaying the traffic transmission till the next drx-OnDuration (i.e., “on-duration of a DRX cycle” or “DRX on-duration”), one possibility is to configure a large drx-OnDuration to cover the jitter range as possible. However, this would lead to limited power saving gain. Another possibility is to apply sparse PDCCH monitoring according to search space sets with group index 0 (e.g., SSSG 0 as shown in FIG. 2) at the start of the drx-OnDuration for power saving, e.g., as shown in FIG. 2. After data arrival, the UE may change to apply dense PDCCH monitoring according to another SSSG (e.g., SSSG 1 as shown in FIG. 2).

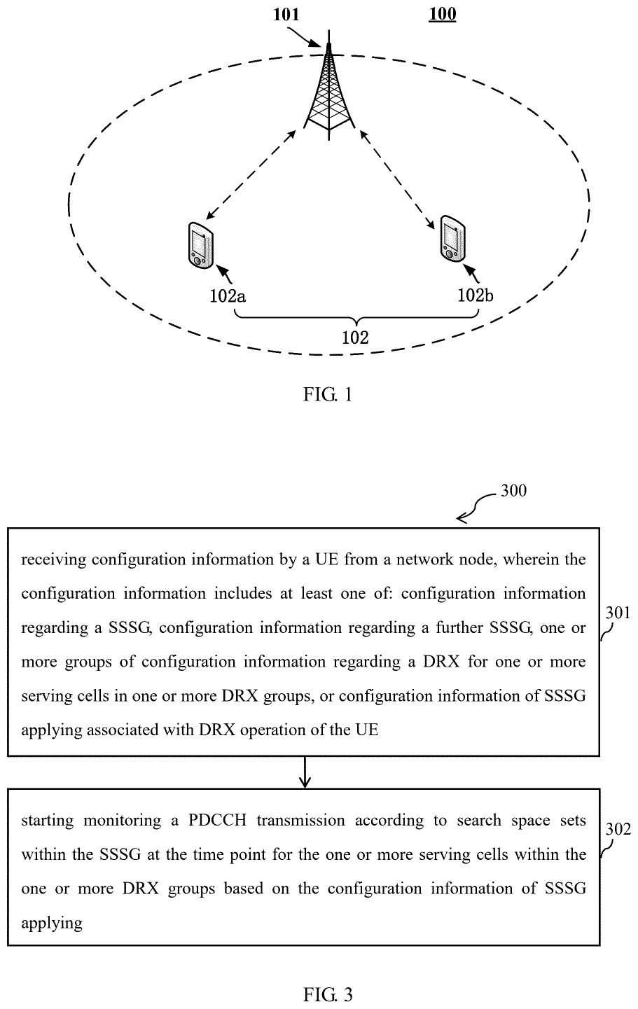

FIG. 2 illustrates an exemplary diagram of applying SSSG in accordance with some embodiments of the present application. FIG. 2 shows “PDCCH monitor occasion in SSSG 0” and “PDCCH monitor occasion in SSSG 1”. In the embodiments of FIG. 2, SSSG 0 is an example of SSSG #1 in the embodiments of FIG. 3, and SSSG 1 is an example of SSSG #2 in the embodiments of FIG. 3.

The embodiments of FIG. 2 show multiple DRX cycles in time domain, and each DRX cycle includes On Duration (e.g., On-Duration #1 or On-Duration #2 as shown in FIG. 2) and an opportunity for DRX. FIG. 2 shows an example of a given SSSG (e.g., SSSG 0) applied at the start slot of On-Duration #1 (i.e., T1 as shown in FIG. 2). For example, SSSG 1 is applied before the start slot of On-Duration #1, i.e., PCCH monitor occasions in SSSG 1 are before T1. Then, SSSG 0 is applied at the start slot of On-Duration #1, i.e., PCCH monitor occasions in SSSG 0 are at and after T1. In some cases, there may be a time offset between (e.g., offset A as shown in FIG. 2) the start slot of On-Duration #1 (i.e., T1) and a start PCCH monitor occasion in SSSG 0 (i.e., T2 as shown in FIG. 2). Then, after data arrival, the UE may change to apply dense PDCCH monitoring occasions according to SSSG 1 again, which is not shown in FIG. 2, and a specific example is described in the embodiments of FIG. 5 as follows.

A SSSG applying solution or mechanism may also be named as a SSSG switching solution or mechanism or the like. For the above SSSG switching solution, following issues need to be addressed: (1) if a UE is expecting to receive PDCCH for critical information, applying search space sets with group index 0 (e.g., SSSG 0) at the start of the DRX on-duration will delay transmission because the search space set monitoring pattern does not align with the non-uniform DRX cycle; and (2) serving cells in a DRX group have the same DRX pattern, and an issue of how to coordinate with the legacy SSSG switching based on cellGroupsForSwitchList needs to be solved.

Embodiments of the present application aim to solve the above issues and design more efficient power saving mechanisms of XR traffic. More specifically, in some embodiments of the present application, to balance transmission delay and power saving for an XR device, a UE may apply a given SSSG with sparse PDCCH monitoring for the serving cells within a DRX group according to the UE's DRX operation based on drx-inactiveTimer and drx-RetransmissionTimerDL etc., for instance: at a start slot of the DRX On duration; and the UE may determine the start slot of a search space set in the given SSSG according to the start slot of the DRX On duration of the serving cell instead of the legacy PDCCH monitor offset; or at a slot that is (at least a time offset) after a slot where a UE is in DRX active time only due to running of drx-onDurationTimer; or at a slot that is (at least a time offset) after the slot where drx-InactivityTimer expires; or at a slot that is (at least a time offset) after a slot where the UE is in DRX active time. In some other embodiments of the present application, the UE applies a given SSSG with dense PDCCH monitoring for the serving cells within a DRX group if receiving DCI in a PDCCH for a new transmission or a retransmission etc.

In the embodiments of present application, SSSG can be replaced by Search Space set defined in SearchSpace in 3GPP TS 38.331, which defines how or where to search for PDCCH candidates. Each search space may be associated with one ControlResourceSet. The IE ControlResourceSet may be used to configure a time or frequency control resource set (CORESET) in which to search for downlink control. More details will be illustrated in following text in combination with the appended drawings.

FIG. 3 illustrates an exemplary flowchart of monitoring a PDCCH transmission in accordance with some embodiments of the present application. The exemplary method 300 in the embodiments of FIG. 3 may be performed by a UE (e.g., UE 102 as shown and illustrated in FIG. 1). Although described with respect to a UE, it should be understood that other devices may be configured to perform a method similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-6. A specific example of exemplary method 300 is described in the embodiments of FIGS. 4 and 5 as follows.

In the exemplary method 300 as shown in FIG. 3, in operation 301, a UE (e.g., UE 102a as shown in FIG. 1) receives configuration information (denoted as configuration #1 for simplicity) from a network node (e.g., BS 101 as shown in FIG. 1). In some embodiments, configuration #1 is received in an RRC message. For instance, configuration #1 may include at least one of.
(1) Configuration information regarding a SSSG (denoted as SSSG #1 for simplicity). For example, SSSG #1 (e.g., search space set group with group index 0, i.e., SSSG 0 in FIGS. 2, 4, and 5) has spare PDCCH monitoring occasion and may include one or more search space sets.
(2) Configuration information regarding another SSSG (denoted as SSSG #2 for simplicity). For example, SSSG #2 (e.g., search space set group with group index 1, i.e., SSSG 1 in FIGS. 2 and 5) having dense PDCCH monitoring occasion and may include one or more search space sets. In an embodiment, both SSSG #1 and SSSG #2 are included in the searchSpaceGroupIdList IE.
(3) One or more groups of configuration information regarding DRX (denoted as DRX-config for simplicity), e.g., including parameters of a DRX cycle and etc. DRX-config may be used to configure DRX related parameters of serving cells in a DRX group, e.g., drx-onDurationTimer, drx-InactivityTimer, drx-HARQ-RTT-TimerDL, drx-HARQ-RTT-TimerUL, drx-RetransmissionTimerDL, drx-RetransmissionTimerUL, drx-LongCycleStartOffset, shortDRX and drx-SlotOffset as defined in 3GPP TS 38.331 with the usage is defined in 3GPP TS 38.321.
(4) Configuration information of SSSG applying (denoted as SSSG-DRX-config for simplicity) associated with DRX operation of the UE.

In operation 302, based on the configuration information of SSSG applying, the UE may start monitoring a physical downlink control channel (PDCCH) transmission according to search space sets within the first SSSG at a first time point for the one or more serving cells within the one or more DRX groups.

In some embodiments of operation 302, the UE may evaluate whether at least one SSSG applying condition based on SSSG-DRX-config is fulfilled at a time point (denoted as time #1 for simplicity) related to the DRX operation of the UE. In some embodiments, time #1 is at least one of:
(1) A start slot of on-duration of a DRX cycle, e.g., T1 as shown in FIG. 4.
(2) A slot after “a slot where the UE is in DRX active time only due to a DRX on-duration timer being running”, e.g., T2 during “DRX on-duration timer is running” as shown in FIG. 4. For instance, the slot may be a time offset (e.g., Y-offset) after “the slot where the UE is in DRX active time only due to a DRX on-duration timer (e.g., drx-onDurationTimer) being running”.
(3) A slot after a slot where a DRX inactivity timer (e.g., drx-InactivityTimer) expires, e.g., T2 during “DRX on-duration timer is running” or T4 during “DRX on-duration timer is not running” as shown in FIG. 4. For instance, the slot may be a time offset (e.g., Y-offset) after a slot where a DRX inactivity timer (e.g., drx-InactivityTimer) expires.
(4) A slot after a last slot where the UE is in the DRX active time, e.g., T2 where the UE stop the DRX on-duration timer before the DRX on-duration timer expires or T4 where the DRX on-duration timer expires as shown in FIG. 4. For instance, the slot may be a time offset (e.g., Y-offset) after the last slot where the UE is in the DRX active time.
(5) A start slot where the UE is in DRX active time only due to a DRX on-duration timer being running, e.g., T1 or T2 as shown in FIG. 4.

In some embodiments of operation 302, in response to fulfillment of the at least one SSSG applying condition at time #1, the UE may start monitoring a PDCCH transmission according to search space sets within SSSG #1 and stop monitoring a PDCCH transmission according to search space sets within SSSG #2 at time #1 for the one or more serving cells within the one or more DRX groups. For example, the UE may switch from SSSG 1 to SSSG 0 at T1 as shown in FIG. 4. SSSG 0 in FIG. 4 is an example of SSSG #1. SSSG 1 in FIG. 4 is an example of SSSG #2.

In in some other embodiments of operation 302, in response to unfulfillment of the one or more SSSG applying conditions at time #1, the UE may not start monitoring a PDCCH transmission according to search space sets within SSSG #1 at time #1 for the one or more serving cells within the one or more DRX groups. For example, the UE may not switch from SSSG 1 to SSSG 0 at T1 if the drx-InactivityTimer is running as shown in FIG. 4. For example, the UE may not switch from SSSG 1 to SSSG 0 at T1 if UE is in DRX active time is not only due to the running drx-onDurationTimer as shown in FIG. 4. For example, the UE may not switch from SSSG 1 to SSSG 0 at T1 if UE is in DRX active time is due to the beam failure recovery procedure, e.g., based on a dedicated (or contention free) RACH preamble or dedicated RACH frequency resource as shown in FIG. 4. In some embodiments, SSSG-DRX-config may be used to enable the UE to apply one SSSG at a start slot of the DRX on-duration or enable the UE to implicitly switch from another SSSG back to the one SSSG. For example, to apply one SSSG is to start monitoring a PDCCH transmission according to search space sets in the one SSSG and stop monitoring a PDCCH transmission according to search space sets in another SSSG. In some embodiments, SSSG-DRX-config is configured per serving cell, per cell group, per DRX group, or per BWP. In some embodiments, SSSG-DRX-config includes at least one of:
(1) Identity information related to SSSG #1. This field may be used to identify SSSG #1; and this information may be not configured by the network node but pre-defined in the standard specification.
(2) Identity information related to SSSG #2. This field is used to identify SSSG #2; and this information may be not configured by the network node but pre-defined in the standard specification(s).
(3) Information for indicating whether to enable a SSSG applying function of the UE. This field may be named as “Enabled” or the like, and may indicate the UE to implicitly apply SSSG #1 at T1, T2 or T4 as shown in FIG. 4. For example, this field is BOOLEAN with value TRUE or FALSE. TRUE indicates that the UE is disabled to implicitly apply SSSG #1 at a start slot of the drx-onDuration. FALSE or absent of SSSG-DRX-config indicates that the UE is disabled to implicitly apply SSSG #1 at the start slot of the drx-onDuration for a serving cell, serving cells in a cell group, serving cells in (or associated with) a DRX group or a BWP.
(4) Identity information related to a search space set associated with on-duration of a DRX cycle. This field may be named as “searchSpace ID” or the like, and may be used to identity a search space set in SSSG #1 to align with the start slot of the drx-Onduration.
(5) A timer related to the SSSG applying function of the UE. This field may be named as “searchSpaceSwitchTimer” or the like, and may be used to indicate the timer (e.g., in unit of slots or symbols) to control the UE's behavior to switch from a search space group (e.g., SSSG 1 or SSSG 0 in FIG. 2, 4, or 5) back to search space group (e.g., SSSG 0 or SSSG 1 in FIG. 2, 4, or 5). This field may be separately configured from the legacy searchSpaceSwitchTimer. The field may be configured per BWP, per serving cell, per cell group or per DRX group.
(6) A delay value applied by the UE during the SSSG applying. This field may be named as “searchSpaceSwitchDelay” or the like, and may be used to indicate the delay value to be applied by the UE for SSSG switching. This field may be separately configured from the legacy searchSpaceSwitchDelay. The field may be configured per BWP, per serving cell, per cell group or per DRX group.
(7) One or more time offsets related to on-duration of the DRX cycle. For instance, SSSG-DRX-config includes a filed “X-offset” that is used to indicate a time offset value prior to the start slot of the (recent or next) drx-onDuration, e.g., to determine TO as shown in FIG. 4. SSSG-DRX-config includes a filed “Y-offset” that is used to indicate time offset value to determine T2 or T4. X-offset and Y-offset may be not configured by the network node but pre-defined in the standard specification(s). In some embodiments, using the value of the legacy searchSpaceSwitchDelay as the time offsets.

In some embodiments, SSSG-DRX-config further includes information related to a DRX group. This field may be named as “Drx-Group information” and may be used to identify one or multiple groups of configuration information regarding DRX (i.e., which may be named as multiple sets of DRX-config or the like) to implicitly apply SSSG #1 at T1, T2 or T4 as shown in FIG. 4. The multiple groups (or sets) of DRX-config may be active in one cell, which may cause multiple active drx cycle with the different start time and/or length of the drx-onduration. For example, each set of DRX-config may have separate DRX parameters including at least one of: identification of one group of DRX configuration, drx-onDurationTimer, drx-InactivityTimer, drx-HARQ-RTT-TimerDL, drx-HARQ-RTT-TimerUL, drx-RetransmissionTimerDL, drx-RetransmissionTimerUL, drx-Cycle, drx-StartOffset, shortDRX and drx-SlotOffset. For some DRX-config, it is not necessary to use the SSSG applying function for short DRX on-duration. Therefore, the network node can control UE using which group of DRX config to this SSSG applying function for avoid the complexity. For example, the value may be ENUMERATED {first, secondary, third, . . . }, wherein first is corresponding to DRX config-1, secondary is corresponding to DRX config-2, and third is corresponding to DRX config-3. For example, the value may be a list of identification of DRX-config.

In an embodiment, SSSG-DRX-config is configured for one cell group associated with only one group of DRX-config. For instance, SSSG-DRX-config is used to enable the SSSG applying based on the one group of DRX-config at T1, T2 or T4 for the serving cells in the cell group. In an example, SSSG-DRX-config may be configured as follows.

| | |
|---|---|
| CellGroupConfig ::= | SEQUENCE { |
| cellGroupId | CellGroupId, |

```
  mac-CellGroupConfig
MAC-CellGroupConfig
OPTIONAL, -- Need M
...,
  [[
  SSSG-DRX-config (including Enabled)
  ]]
}
```

In an embodiment, SSSG-DRX-config is configured for one cell group associated with one of more DRX groups. For example, when the serving cells in the one cell group are assigned to more than one group of DRX-config. SSSG-DRX-config is used to indicate the SSSG applying based on which group of DRX-config at T1, T2 or T4 for the serving cells in the cell group. In a further example, SSSG-DRX-config may be configured as follows.

| | |
|---|---|
| CellGroupConfig ::= | SEQUENCE { |
| cellGroupId | CellGroupId, |

```
    mac-Cell GroupConfig
  MAC-CellGroupConfig
  OPTIONAL, -- Need M
    ...,
    [[
      SSSG-DRX-config (including Drx-Group information)
    ]]
}
```

In a further embodiment, SSSG-DRX-config is configured for a serving cell. If the serving cell is assigned to only one group of DRX-config, SSSG-DRX-config includes the value Enabled to indicate the SSSG applying based on which group of DRX-config at T1, T2 or T4 for the serving cell. If the serving cell is assigned to more than one group of DRX-config, SSSG-DRX-config is used to indicate the SSSG applying based on which group of DRX-config at T1, T2 or T4 for the serving cell associated with one of more DRX groups. For instance, it may be configured as follows.

```
ServingCellConfig ::= SEQUENCE {
  [[
    SSSG-DRX-config (including Enabled or Drx-Group information)
    ]]
}
```

In another embodiment, SSSG-DRX-config is configured for one BWP. For instance, SSSG-DRX-config is associated with one BWP. In an example, SSSG-DRX-config may be configured as follows.

| PDCCH-Config ::= | SEQUENCE { |
|---|---|
| searchSpacesToAddModList | SEQUENCE(SIZE (1..10)) |
| OF SearchSpace | OPTIONAL, -- Need |
| N | |
| ..., | |
| [[ | |
| searchSpacesToAddModListExt-r16 | SEQUENCE(SIZE (1..10)) |
| OF SearchSpaceExt-r16 | OPTIONAL, -- Need N |
| searchSpaceSwitchConfig-r16 | SearchSpaceSwitchConfig-r16 |
| OPTIONAL -- Need R | |
| ]], | |
| ]] | |
| searchSpacesToAddModListExt-v1700 | SEQUENCE(SIZE (1..10)) |
| OF SearchSpaceExt-v1700 | OPTIONAL, -- Need N |
| searchSpaceSwitchTimer-r17 | INTEGER (1..800) |

```
OPTIONAL, -- Need R
  ]]
[[
SSSG-DRX-config (including Enabled)
  ]],
}
```

Referring back to operation 302 in FIG. 3, in some embodiments, the fulfillment of the at least one SSSG applying condition includes at least one of following cases. In other words, the UE may evaluate whether at least one of following cases occurs, and once at least one case occurs, the UE may determine that the at least one SSSG applying condition is fulfilled. Specific examples are described in operation 412 in Embodiment 1 of FIG. 4 as follows.
(1) The UE is in DRX active time for the one or more serving cells at a start slot of on-duration of a DRX cycle only due to a DRX on-duration timer being running.
(2) No reception of an indication (e.g., a field in DCI) for indicating the UE to start monitoring the PDCCH transmission according to SSSG #2 on the one or more serving cells “during a time period of a time offset (e.g., X-offset) before a start slot of on-duration of the DRX cycle (e.g., the time period ending at T1)” or “at/till another time point (denoted as time #2 for simplicity, e.g., TO) with the time offset (e.g., X-offset) before the start slot of on-duration of the DRX cycle, e.g., T1”.
(3) No reception of DCI scrambled by a RNTI (e.g., C-RNTI or CS-RNTI or MCS-C-RNTI) on the one or more serving cells “during the time period of the time offset (e.g., X-offset) before the start slot of on-duration of the DRX cycle (e.g., the time period ending at T1)” or “at/till time #2, e.g., TO”.
(4) A MAC entity is not monitoring the PDCCH transmission on a search space (e.g., indicated by recoverySearchSpaceId) for beam failure recovery of the one or more serving cells “during the time period of the time offset (e.g., X-offset) before the start slot of on-duration of the DRX cycle or at the start slot of on-duration of the DRX cycle” or “at/till time #2”.
(5) At least one of “multiple timers including a DRX inactivity timer, a RA contention resolution timer, a msgB response timer, DRX retransmission timer for downlink, and DRX retransmission timer for uplink of the one or more serving cells” is not running “during the time period of the time offset (e.g., X-offset) before the start slot of on-duration of the DRX cycle or at the start slot of on-duration of the DRX cycle” or “at/till time #2”. For example, the multiple timers may include drx-InactivityTimer, ra-ContentionResolutionTimer, msgB-ResponseWindow, drx-RetransmissionTimerDL, or drx-RetransmissionTimerUL.
(6) The UE is in DRX inactive time for the one or more serving cells “during the time period of the time offset (e.g., X-offset) before the start slot of on-duration of the DRX cycle” or “at/till time #2”.

In some embodiments, the fulfillment of the at least one SSSG applying condition includes at least one of following cases. Specific examples are described in operation 422 in Embodiment 2 of FIG. 4 as follows.
(1) No DCI is detected at a slot where the UE is in DRX active time only due to a DRX on-duration timer being running, “at/till a slot after a slot where the UE is in the DRX active time only due to the DRX on-duration timer being running, e.g., T2”, “at a slot where a DRX inactivity timer expires”, “at/till a slot after a slot where the DRX inactivity timer expires, e.g., T2 or T4”, “at a last slot where the UE is in the DRX active time”, or “at/till a slot after a last slot where the UE is in the DRX active time, e.g., T2 or T4”, e.g., T2 during “DRX on-duration timer is running” or T4 during “DRX on-duration timer is not running”.
(2) No SR is sent or being pending at a slot where the UE is in DRX active time only due to the DRX on-duration timer being running, “at/till a slot after a slot where the UE is in the DRX active time only due to the DRX on-duration timer being running”, “at a slot where the DRX inactivity timer expires”, “at/till a slot after a slot where the DRX inactivity timer expires”, “at a last slot where the UE is in the DRX active time”, or “at/till a slot after a last slot where the UE is in the DRX active time”, e.g., T2 during “DRX on-duration timer is running” or T4 during “DRX on-duration timer is not running”.
(3) Reception of a PDCCH transmission indicating a new transmission at a slot where the UE is in the DRX active time only due to the DRX on-duration timer being running, “at/till a slot after a slot where the UE is in the DRX active time only due to the DRX on-duration timer being running”, “at a slot after successful reception of a RA response”, “at a slot where the DRX inactivity timer expires”, “at/till a slot after a slot where the DRX inactivity timer expires”, “at a last slot where the UE is in the DRX active time”, or “at/till a slot after a last slot where the UE is in the DRX active time”, e.g., T2 during “DRX on-duration timer is running” or T4 during “DRX on-duration timer is not running”.
(4) A MAC entity is not monitoring the PDCCH transmission on a search space for beam failure recovery of the one or more serving cells at a slot where the UE is in the DRX active time only due to the DRX on-duration timer being running “at/till a slot after a slot where the UE is in the DRX active time only due to the DRX on-duration timer being running”, “at a slot where the DRX inactivity timer expires, at/till a slot after a slot where the DRX inactivity timer expires”, “at a last slot where the UE is in the DRX active time”, or “at/till a slot after a last slot where the UE is in the DRX active time”, e.g., T2 during “DRX on-duration timer is running” or T4 during “DRX on-duration timer is not running”.

In some embodiments, the UE may receive a search space group identity list, e.g., searchSpaceGroupIdList, and reset to monitor the PDCCH transmission according to SSSG #1 upon reception of at least one of SSSG-DRX-config or the search space group identity list. For example, the UE may receive SSSG-DRX-config and/or searchSpaceGroupIdList in operation 301. Then, the UE may optionally reset PDCCH monitoring according to search space sets with SSSG #1.

In some embodiments, in response to fulfillment of the at least one SSSG applying condition at time #1, the UE may stop monitoring the PDCCH transmission in search space sets within SSSG #2. For example, the UE may switch from SSSG #2 to SSSG #1.

In some other embodiments, in response to unfulfillment of the one or more SSSG applying conditions at time #1, the UE may not stop monitoring the PDCCH transmission in search space sets within SSSG #2. For example, the UE may not switch from SSSG #2 to SSSG #1.

In some embodiments, in response to starting monitoring the PDCCH transmission according to the search space sets within SSSG #1, the UE may stop a search space switch timer in response to that the search space switch timer is running. For example, the UE may stop searchSpaceSwitchTimer.

In some embodiments, the UE may stop monitoring the PDCCH transmission in the search space sets within SSSG #1 and start monitoring the PDCCH transmission according to search space sets within SSSG #2, in response to at least one of following cases. Specific examples are described in operation 503 in the embodiments of FIG. 5 as follows, in which the UE may switch at T5 from SSSG #1 to SSSG #2 e.g., during “the DRX on-duration timer is running”.
(1) Reception of DCI. The DCI indicates a new transmission or a retransmission for the UE. For example, the DCI indicates a new transmission or a retransmission of data on a specified DRB or logical channel, which can be preconfigured by the network node.
(2) Starting a RA response timer (e.g., ra-ResponseWindow) for monitoring a PDCCH transmission on a search space of the one or more serving cells. For example, the DCI indicates a specified preamble, which can be preconfigured by the network node.
(3) Starting a DRX retransmission timer for downlink, e.g., drx-RetransmissionTimerDL. For example, the DCI indicates a retransmission of data on a specified DRB or logical channel, which can be preconfigured by the network node.
(4) Starting a DRX retransmission timer for uplink, e.g., drx-RetransmissionTimerUL. For example, the DCI indicates a retransmission of data on a specified DRB or logical channel, which can be preconfigured by the network node.
(5) Starting a RA contention resolution timer, e.g., ra-ContentionResolutionTimer.
(6) Starting a msgB response timer, e.g., msgB-Response Window.
(7) Transmitting SR on a PUCCH transmission. For example, the DCI indicates a SR config associated with a specified logical channel, which can be preconfigured by the network node.

In some embodiments, the UE may determine a start slot of the search space sets in SSSG #1 according to a start slot of on-duration of a DRX cycle for the one or more serving cells. In this embodiment, the UE aligns the start slot of PDCCH monitoring for a search space set in SSSG #1 with the drx-Onduration.

For instance, in operation 301, SSSG-DRX-config optionally indicates a search space searchSpace ID=s, which is identified a search space set in SSSG #1 to align with drx-Onduration. In operation 302, if the UE implicitly starts monitoring PDCCH according to SSSG #1 and stop monitoring PDCCH according to SSSG #2 for the serving cell, the UE may determine the start slot of a search space set “s” in the SSSG #1 according to start slot of the DRX on-duration of the serving cell.

For example, for a given period of continuous active time for PDCCH monitoring on a BWP of the serving cell, for search space set “s”, the UE may determine that PDCCH monitoring occasions exist in a slot with number

$${n}_{s , f}^{µ}$$

[TS 38.211] in a frame with number n_f if n_f is according to the following formula:

$$( n\_f * {N}_{slot}^{frame , µ} + {n}_{s , f}^{µ} - {o}_{s} ) mod {k}_{s} = O$$

wherein set Oₛ=o_{DRX}, the search space set “s” is associated with a DRX group, for example, “s” is “(4) Identity information related to a search space set associated with on-duration of a DRX cycle” specified by the network node. Parameter o_{DRX} is the most recent starting time of drx-onDurationTimer in time slots, i.e., o_{DRX} is updated every time that drx-onDurationTimer starts, by using the formula:

$${o}_{DRX} = ( [ ( SFN \times 10 ) + subframe number ] \times {N}_{slot}^{subframe , µ} ) + drx - SlotOffset$$

where SFN and the subframe number are the most recent ones that satisfy the condition for starting the drx-onDurationTimer.
Wherein a PDCCH monitoring periodicity of kₛ slots and a PDCCH monitoring offset of Oₛ slots, is defined by monitoringSlotPeriodicityAndOffset in TS 38.331.

In some embodiments, to start monitoring the PDCCH transmission according to the search space sets in SSSG #1 in operation 302, the UE may be bundled to start monitoring the PDCCH transmission at time #1 for all the one or more serving cells within the one or more DRX groups or for a subset within the one or more serving cells within the one or more DRX groups. The subset may be configured with SSSG-DRX-config. For instance, the serving cells in a DRX group are bundled for the above search space group switching purpose. There may be following options in different embodiments, i.e., Option 1, Option 2, Option 3, and Option 4.
(1) Option 1: If the UE is provided cellGroupsForSwitchList, indicating one or more groups of serving cells, the above SSSG switching procedures in the embodiments of FIG. 3 apply to all serving cells within each group if the above one SSSG applying condition is fulfilled only in one serving cell. The serving cells configured with SSSG-DRX-config within a DRX group should only belong to one cell group in the cellGroupsForSwitchList. For example, if serving cell 1 and serving cell 2 are configured with SSSG-DRX-config within a DRX group, they should be unique in the same cell group in cellGroupsForSwitchList. Or, all the serving cells within a DRX group should only belong to one cell group in the cellGroupsForSwitchList if there's one serving cell configured with SSSG-DRX-config in the DRX group. For example, if serving cell 1 and serving cell 2 are within a DRX group, only serving cell 1 is configured with SSSG-DRX-config, they both should be unique in the same cell group in cellGroupsForSwitchList.
(2) Option 2: If the UE is provided SSSG-DRX-config and not provided legacy cellGroupsForSwitchList, the above SSSG switching procedures in embodiments of FIG. 3 apply to all serving cells configured with SSSG-DRX-config within a DRX group or all the serving cells in the DRX group if there's one serving cell configured with SSSG-DRX-config in the DRX group. Otherwise, the above procedures apply only to a serving cell for which the UE is provided searchSpaceGroupIdList.
(3) Option 3: If the UE is provided SSSG-DRX-config and legacy cellGroupsForSwitchList, the one cell group including a serving cell configured with SSSG-DRX-config in the cellGroupsForSwitchList may be ignored. For example, if a serving cell configured with SSSG-DRX-config is included in a cell group in the cellGroupsForSwitchList, the cell group may be ignored by the UE. The above SSSG switching procedures in in embodiments of FIG. 3 apply to all serving cells configured with SSSG-DRX-config within the DRX group.
(4) Option 4: The cellGroupsForSwitchList is optionally present if the UE is not provided SSSG-DRX-config for a serving cell in the DRX group. That is, in Option 4, only when the UE is not provided SSSG-DRX-config for a serving cell in the DRX group, the one cellGroupForSwitch including the serving cells in the DRX group in the cellGroupsForSwitchList is possibly configured. If the UE is provided SSSG-DRX-config, the cellGroupsForSwitchList should not be configured.

In an embodiment, in response to reception of both “information related to a cell group bundled for SSSG switching (e.g., cellGroupsForSwitchList)” and “SSSG-DRX-confg in one DRX group within the one or more DRX groups” in operation 301, the UE may ignore information related to the cell group for SSSG switching including the serving cells with SSSG-DRX-config in the DRX group or all the serving cells in the DRX group if one serving cell is configured with SSSG-DRX-config.

In some embodiments, each serving cell within the one or more serving cells in one or more DRX groups is uniquely assigned to one DRX group of the one or more DRX groups, and multiple DRX parameters of each DRX group within the one or more DRX groups include:
(1) One or more DRX parameters that are commonly configured to the one or more DRX groups. For instance, the commonly configured DRX parameters include at least one of: drx-SlotOffset, drx-RetransmissionTimerDL, drx-RetransmissionTimerUL, drx-LongCycleStartOffset, drx-ShortCycle, drx-ShortCycleTimer, drx-HARQ-RTT-TimerDL, and drx-HARQ-RTT-TimerUL.
(2) One or more DRX parameters that are separately configured for the each DRX group.

In some embodiments, each serving cell within the one or more serving cells in one or more DRX groups is assigned to two or more DRX groups within the one or more DRX groups, and one or more DRX parameters are separately configured for each DRX group within the two or more DRX groups. For instance, the separately configured DRX parameters for each DRX group include at least one of: identification of one group of DRX configuration, drx-onDurationTimer, drx-InactivityTimer, drx-SlotOffset, drx-RetransmissionTimerDL, drx-RetransmissionTimerUL, drx-LongCycleStartOffset, drx-ShortCycle, drx-ShortCycleTimer, drx-HARQ-RTT-TimerDL, and drx-HARQ-RTT-Timer UL.

Some other embodiments of the present application provide an exemplary procedure performed by a network node, e.g., BS 101 as shown in FIG. 1. Although described with respect to a network node, it should be understood that other devices may be configured to perform a similar method. In this exemplary procedure, the network node may transmit configuration information (denoted as configuration #1 for simplicity) to a UE (e.g., UE 102 as shown and illustrated in FIG. 1) for one or more serving cells in one or more DRX groups. In some embodiments, configuration #1 is transmitted in an RRC message. For instance, configuration #1 may include at least one of:
(1) configuration information regarding a SSSG (denoted as SSSG #1 for simplicity);
(2) configuration information regarding another SSSG (denoted as SSSG #2 for simplicity);
(3) one or more groups of configuration information regarding DRX (denoted as DRX-config for simplicity); or
(4) configuration information of SSSG applying associated with DRX operation of the UE (denoted as SSSG-DRX-config for simplicity). In some embodiments, SSSG-DRX-config may be used to enable the UE to start monitoring a PDCCH transmission according to search space sets within SSSG #1 at a time point (denoted as time #1 for simplicity) for the one or more serving cells within the one or more DRX groups. In some embodiments, time #1 is at least one of:
   a) a start slot of on-duration of a DRX cycle, e.g., T1 as shown in FIG. 4;
   b) a slot after a slot where the UE is in DRX active time only due to a DRX on-duration timer being running, e.g., T2 during “DRX on-duration timer is running” as shown in FIG. 4;
   c) a slot after a slot where a DRX inactivity timer expires, e.g., T2 during “DRX on-duration timer is running” or T4 during “DRX on-duration timer is not running” as shown in FIG. 4; or
   d) a slot after a last slot where the UE is in the DRX active time, e.g., T2 where UE stop the DRX on-duration timer before the DRX on-duration timer expires or T4 where the DRX on-duration timer expires as shown in FIG. 4.
   e) A start slot where the UE is in DRX active time only due to a DRX on-duration timer being running, e.g., T1 or T2 as shown in FIG. 4.

In some embodiments, each serving cell within the one or more serving cells is uniquely assigned to one DRX group of the one or more DRX groups, and multiple DRX parameters of each DRX group within the one or more DRX groups include:
(1) one or more DRX parameters that are commonly configured to the one or more DRX groups; and
(2) one or more DRX parameters that are separately configured for the each DRX group.

In some embodiments, each serving cell within the one or more serving cells is assigned to two or more DRX groups within the one or more DRX groups, and one or more DRX parameters are separately configured for each DRX group within the two or more DRX groups.

In some embodiments, configuration #1 includes information related to a cell group bundled for SSSG switching (e.g., cellGroupsForSwitch in cellGroupsForSwitchList), and the serving cells for the SSSG applying in one DRX group within the one or more DRX groups only belong to one cell group bundled for SSSG switching. In other words, if configuration #1 includes cellGroupsForSwitchList, it means that two or more serving cells for the SSSG applying in one DRX group belong to the same cell group bundled for SSSG switching, and these two or more serving cells will switch SSSG at the same time.

In some embodiments, SSSG-DRX-config is configured per serving cell, per cell group, per DRX group, or per BWP. In some embodiments, SSSG-DRX-config includes at least one of:
(1) identity information related to SSSG #1;
(2) identity information related to SSSG #2;
(3) information for indicating whether to enable a SSSG applying function of the UE, e.g., “Enabled”;
(4) identity information related to a search space set associated with on-duration of a DRX cycle, e.g., searchSpace ID;
(5) a timer related to the SSSG applying function of the UE, e.g., searchSpaceSwitchTimer;
(6) a delay value applied by the UE during the SSSG applying, e.g., searchSpaceSwitchDelay; or
(7) one or more time offsets related to on-duration of the DRX cycle, e.g., X-offset and/or Y-offset.

FIG. 4 illustrates an exemplary diagram of applying SSSG in accordance with some embodiments of the present application. In the embodiments of FIG. 4, following time points are defined as follows.
(1) T1: at the (beginning of) start (or initial or first) slot of the (recent or next) drx-onDuration of the DRX cycle.
(2) T0: at the slot that is at least X-offset slots/symbols/ms (e.g., the value of searchSpaceSwitchDelay or X-offset in SSSG-DRX-config) prior to the start slot of the (recent or next) drx-onDuration of the DRX cycle.
(3) T2: at a slot during drx-onDuration window, including at least one of the time points:
   a start slot that is (at least Y-offset slots/symbols/ms, e.g., the value of searchSpaceSwitchDelay or Y-offset in SSSG-DRX-config) after the start slot of a DRX On duration of the DRX cycle;
   a start slot that is (at least Y-offset slots/symbols/ms) after the slot where the drx-InactivityTimer expires;
   a start slot that is (at least Y-offset slots/symbols/ms) after a first or last slot where UE is in DRX active time only due to at the running drx-onDurationTimer;
   a start slot that is (at least Y-offset slots/symbols/ms) after a last slot where UE is in DRX active time;
      For example, if a DRX Command MAC CE or a Long DRX Command MAC CE is received, the UE stops the drx-onDurationTimer and drx-InactivityTimer;
      For example, end indicator of a burst is received, the UE stops the drx-onDurationTimer and drx-InactivityTimer;
   the last slot of a measurement gap during the drx-onDurationTimer is running;
   a start slot that is (at least Y-offset slots/symbols/ms) after the last slot of a measurement gap during drx-onDurationTimer is running;
   a start slot that is (at least Y-offset slots/symbols/ms) after the slot where the ra-ContentionResolutionTimer expires;
   a start slot that is (at least Y-offset slots/symbols/ms) after the slot where the msgB-ResponseWindow expires;
   a start slot that is (at least Y-offset slots/symbols/ms) after the slot where the drx-RetransmissionTimerDL expires;
   a start slot that is (at least Y-offset slots/symbols/ms) after the slot where the drx-RetransmissionTimerUL expires;
(4) T3: the start slot of the (recent or next) drx-onDurationTimer expires.
(5) T4: a slot during drx-onDurationTimer is not running, including at least one of the time points:
   a start slot that is (at least Y-offset slots/symbols/ms) (e.g., the value of searchSpaceSwitchDelay) after T3
   a start slot that is (at least Y-offset slots/symbols/ms) after the slot where drx-InactivityTimer expires
   a start slot that is (at least Y-offset slots/symbols/ms) after the slot where drx-RetransmissionTimerDL expires.
   a start slot that is (at least Y-offset slots/symbols/ms) after the slot where drx-RetransmissionTimerUL expires.
   at a start slot that is (at least Y-offset slots/symbols/ms) after the slot where ra-ContentionResolutionTimer expires;
   at a start slot that is (at least Y-offset slots/symbols/ms) after the slot where msgB-ResponseWindow expires;
   the a start that is (at least Y-offset slots/symbols/ms) after a last slot where UE is in DRX active time.

FIG. 4 shows “PDCCH monitor occasion in SSSG 0”. In the embodiments of FIG. 4, SSSG 0 is an example of SSSG #1 in the embodiments of FIG. 3, and SSSG 1 (not shown in FIG. 4) is an example of SSSG #2 in the embodiments of FIG. 3. There may be following three sub-embodiments of the embodiments of FIG. 4 in different scenarios, i.e., Embodiment 1, Embodiment 2, and Embodiment 3.

### Embodiment 1

Embodiment 1 refers to an example of a SSSG applied according to DRX operation at T1. In Embodiment 1, to avoid transmission delay, a UE may implicitly apply one SSSG for PDCCH monitoring pattern on a serving cell at a start slot of the DRX on-duration or the DRX cycle according to DRX operation of the UE. Following operations 411 and 412 may be performed in Embodiment 1.

In operation 411 of Embodiment 1, a BS may send configuration information regarding SSSG #1 (e.g., SSSG 0 as shown in FIG. 4), configuration information regarding SSSG #2 (e.g., SSSG 1 not shown in FIG. 4), SSSG-DRX-config and DRX-config for a serving cell within a DRX group to a UE in an RRCReconfiguration message. For instance, the UE may receive SSSG-DRX-config and/or searchSpaceGroupIdList in operation 411. Then, the UE may optionally reset PDCCH monitoring according to search space sets with SSSG #1.

In operation 412 of Embodiment 1, the UE starts monitoring PDCCH for the serving cells in a DRX group configured with SSSG-DRX-config and searchSpaceGroupIdList according to the search space sets SSSG #1 (e.g., SSSG 0 as shown in FIG. 4) and stops monitoring PDCCH according to the search space sets in SSSG #2 (e.g., SSSG 1 not shown in FIG. 4) at the start slot of On-Duration #1 of the DRX cycle, i.e., T1. For example, the UE may determine the start slot of the drx-onduration according to legacy DRX formular in TS 38.321. The UE may optionally stop the searchSpaceSwitchTimer if it is running at the start slot of On-Duration #1, i.e., T1.

For example, the UE may perform operation 412 of Embodiment 1 optimally if at least one of the conditions is met:
If an field in the DCI to indicate UE start monitoring PDCCH according to the second SSSG is not received on the serving cell in the DRX group at/till TO or T1 or during a time period of a time offset (e.g., X-offset) before TO or T1;
If DCI in PDDCH scrambled by C-RNTI or CS-RNTI or MCS-C-RNTI or SFI-RNTI or AI-RNTI is not received on the serving cell in the DRX group at/till TO or T1 or during a time period of a time offset (e.g., X-offset) before TO or T1;
If the MAC entity is not monitoring for a PDCCH transmission on the search space indicated by recoverySearchSpaceId of the serving cell (e.g., SpCell within the DRX group) identified by the C-RNTI (while the ra-ResponseWindow is running) at/till TO or T1 or during a time period of a time offset (e.g., X-offset) before TO or T1;
If drx-InactivityTimer configured for the DRX group is not running at/till TO or T1 or during a time period of a time offset (e.g., X-offset) before TO or T1;
If ra-ContentionResolutionTimer on a Serving Cell in the DRX group is not running at/till TO or T1 or during a time period of a time offset (e.g., X-offset) before TO or T1;
If msgB-ResponseWindow on a Serving Cell in the DRX group is not running at/till TO or T1 or during a time period of a time offset (e.g., X-offset) before TO or T1;
If drx-RetransmissionTimerDL on a Serving Cell in the DRX group is not running at/till TO or T1 or during a time period of a time offset (e.g., X-offset) before TO or T1;
If drx-Retransmission TimerUL on a Serving Cell in the DRX group is not running at/till TO or T1 or during a time period of a time offset (e.g., X-offset) before TO or T1;
If drx-HARQ-RTT-TimerUL on a Serving Cell in the DRX group is not running at/till TO or T1 or during a time period of a time offset (e.g., X-offset) before TO or T1;
If drx-HARQ-RTT-TimerDL on a Serving Cell in the DRX group is not running or the downlink HARQ feedback is ACK at/till TO or T1 or during a time period of a time offset (e.g., X-offset) before TO or T1;
If UE is in DRX inactive time for Serving Cells in a DRX group at/till TO or T1 or during a time period of a time offset (e.g., X-offset) before TO or T1.
   For example, if a DRX Command MAC CE or a Long DRX Command MAC CE is received.
   For example, end indicator of a burst is received.
If the start slot of the DRX on-duration does not occur during a measurement gap at/till TO or T1 or during a time period of a time offset (e.g., X-offset) before TO or T1;
If no SR is sent or is pending on a Serving Cell in the DRX group at/till TO or T1 or during a time period of a time offset (e.g., X-offset) before TO or T1;
If a PDCCH indicating a new transmission addressed to the C-RNTI of the MAC entity of a serving cell in the DRX group has not been received at/till TO or T1 or during a time period of a time offset (e.g., X-offset) before TO or T1 after successful reception of a Random Access Response for the Random Access Preamble not selected by the MAC entity among the contention-based Random Access Preamble. In other words, the UE is expecting a PDCCH indicating a new transmission of the serving cell.

In an embodiment, the UE may perform operation 412 of Embodiment 1 as follows:
If a UE is not provided SearchSpaceSwitch Trigger for a serving cell,
   if the UE detects a DCI format by monitoring PDCCH according to a search space set with group index 0, the UE starts monitoring PDCCH according to search space sets with group index 1, and stops monitoring PDCCH according to search space sets with group index 0, for the serving cell
      at the beginning of a start slot that is at least P_{switch} symbols after the last symbol of the PDCCH with the DCI format when μ∈{0, 1, 2, 3}.
      at the beginning of a start slot, of a group of Xₛ slots, that is at least P_{switch} symbols after the last symbol of the PDCCH with the DCI format when μ∈{5, 6}.
The UE sets the timer value to the value provided by searchSpaceSwitchTimer if the UE detects a DCI format by monitoring PDCCH in any search space set.
   if the UE monitors PDCCH for a serving cell according to search space sets with group index 1, the UE starts monitoring PDCCH for the serving cell according to search space sets with group index 0, and stops monitoring PDCCH according to search space sets with group index 1, for the serving cell
      at the beginning of a start slot that is at least P_{switch} symbols after a slot where the timer expires or, if the UE is provided a search space set to monitor PDCCH for detecting a DCI format 2_0, after a last symbol of a remaining channel occupancy duration for the serving cell if indicated by DCI format 2_0 when r t or,
      at the beginning of a start slot where of the DRX-onDuration Timer starts if a UE is provided SSSG-DRX-config for a server cell within a DRX group and if UE is not in DRX active time at/till the slot that is at X-offset symbols prior to the slot where of the DRX-onDurationTimer starts or,
      at the beginning of a start slot where of the DRX-onDuration Timer starts if a UE is provided SSSG-DRX-config for a server cell within a DRX group and if the DRX-inactivityTimer is not running at the slot where of the DRX-onDurationTimer starts or,
      at the beginning of a start slot where of the DRX-onDuration Timer starts if a UE is provided SSSG-DRX-config for a server cell within a DRX group and if the DRX-inactivityTimer is not running at the slot that is at X-offset symbols prior to the slot where of the DRX-onDurationTimer starts.

In another embodiment, the UE may perform operation 412 of Embodiment 1 as follows:
1> if SSSG-DRX-config information is configured for the DRX group,
   2> possibility 1: and if SSSG switch indication is not received from lower layer indicated to start of PDCCH monitoring according to search space sets except group index 0 at/till a start slot that is X-offset symbols prior to the start slot of the DRX cycle or during a time period of a time offset (e.g., X-offset) before the start slot of the DRX cycle; or
   2> possibility 2: and if the timing instance at a start slot that is X-offset prior to the start slot of the drx-onDurationTimer of the DRX group or during a time period of a time offset (e.g., X-offset) before the start slot of the DRX cycle, is not in Active Time; or
   2> possibility 3: if the timing instance at the start slot of drx-onDurationTimer of the DRX group, is in Active Time only due to the drx-onDurationTimer; or
   2> possibility 4: if the drx-inactivity timer is not running at the start slot of drx-onDurationTimer;
      3> the UE starts monitoring PDCCH for the serving cell according to SSSG #1 at the start slot of the drx-onDurationTimer of the DRX group.

### Embodiment 2

Embodiment 2 refers to an example of a SSSG applied according to DRX operation at T2. In Embodiment 2, to balance the transmission delay and power consumption for PDCCH monitoring, a UE implicitly apply a SSSG for PDCCH monitoring on a serving cell at a time point after the start slot of the DRX on-duration or the DRX cycle according to UE operation during the drx-onDuration. Following operations 421 and 422 may be performed in Embodiment 2.

In operation 421 of Embodiment 2, a BS may send configuration information regarding SSSG #1 (e.g., SSSG 0 as shown in FIG. 4), configuration information regarding SSSG #2 (e.g., SSSG 1 not shown in FIG. 4), SSSG-DRX-config and DRX-config for a serving cell within a DRX group to a UE in an RRCReconfiguration message.

In operation 422 of Embodiment 2, the UE may start monitoring PDCCH for the serving cell in a DRX group configured with SSSG-DRX-config and searchSpaceGroupIdList according to the search space sets in SSSG #1 (e.g., SSSG 0 as shown in FIG. 4) and stops monitoring PDCCH according to the search space sets in SSSG #2 (e.g., SSSG 1 not shown in FIG. 4) at T2.

For example, the UE may perform operation 422 of Embodiment 2 optimally if at least one of the conditions is met:
If no DCI is detected during a time period of a time offset (e.g., X-offset) before the start slot of T2 or at/till (the start slot that is at least Y-offset slots/symbols/ms prior to) T2; for example, if no DCI to indicate UE start monitoring PDCCH according to the second SSSG is detected during a time period of a time offset (e.g., X-offset) before the start slot of T2 or at/till the start slot that is at least Y-offset slots/symbols/ms prior to T2; for example, if no DCI in PDCCH reception in the slot for with CRC scrambled by C-RNTI/CS-RNTI/MCS-C-RNTI/SFI-RNTI is detected during a time period of a time offset (e.g., X-offset) before the start slot of T2 or at/till the start slot that is at least Y-offset slots/symbols/ms prior to T2;
If no SR is sent or is pending during a time period of a time offset (e.g., X-offset) before the start slot of T2 or at/till (the start slot that is at least Y-offset slots/symbols/ms prior to) T2.
If a PDCCH indicating a new transmission addressed to the C-RNTI of the MAC entity has been received during a time period of a time offset (e.g., X-offset) before the start slot of T2 or at/till (the start slot that is at least Y-offset slots/symbols/ms prior to) T2 after successful reception of a Random Access Response for the Random Access Preamble not selected by the MAC entity among the contention-based Random Access Preamble;
If the MAC entity is not monitoring for a PDCCH transmission on the search space indicated by recoverySearchSpaceId of the serving cell (e.g., Pcell or PScell) identified by the C-RNTI (while the ra-ResponseWindow is running) during a time period of a time offset (e.g., X-offset) before the start slot of T2 or at/till (the start slot that is at least Y-offset slots/symbols/ms prior to) T2.
If the drx-inactivity timer is not running and the drx-onDurationTimer is running at the start slot that is at least Y-offset slots/symbols/ms prior to the T2.

An example of operation 422 of Embodiment 2 is as follows:
1> if SSSG-DRX-config information is configured for the DRX group,
   2> possibility 1: and if SSSG switch indication is not received from lower layer indicated to start of PDCCH monitoring according to search space sets except group index 0 during a time period of a time offset (e.g., X-offset) after the start slot (e.g., Y-offset) of the timing instance where the drx-inactivity timer expires or stops; or
      3> the UE starts monitoring PDCCH for the serving cell according to SSSG #1 at the slot that is a time offset (e.g., Y-offset) after the slot (if the drx-onDurationTimer is running).
   2> possibility 2: and if the timing instance at the last slot where the UE is not in Active Time; or
      3> the UE starts monitoring PDCCH for the serving cell according to SSSG #1 at the slot that is a time offset (e.g., Y-offset) after the slot (if the drx-onDurationTimer is running).
   2> possibility 3: if the timing instance at a start slot where UE is in Active Time only due to the drx-onDurationTimer; or
      3> the UE starts monitoring PDCCH for the serving cell according to SSSG #1 at a time offset (e.g., Y-offset) after the slot.
   2> possibility 4: if the timing instance at the slot where the drx-inactivity timer expires or stops and the drx-onDurationTimer is running;
      3> the UE starts monitoring PDCCH for the serving cell according to SSSG #1 at a time offset (e.g., Y-offset) after the slot.

### Embodiment 3

Embodiment 3 refers to an example of a SSSG applied according to DRX operation at T4. In Embodiment 3, to avoid transmission delay, a UE may implicitly apply SSSG #1 for PDCCH monitoring on a serving cell at a time point after the start slot of the DRX on-duration or the DRX cycle according to the UE's operation when the drx-onDurationTimer is not running. Following operations 431 and 432 may be performed in Embodiment 3.

In operation 431 of Embodiment 3, a BS may send configuration information regarding SSSG #1 (e.g., SSSG 0 as shown in FIG. 4), configuration information regarding SSSG #2 (e.g., SSSG 1 not shown in FIG. 4), SSSG-DRX-config and DRX-config for a serving cell within a DRX group to the UE in an RRCReconfiguration message.

In operation 432 of Embodiment 3, the UE may starts monitoring PDCCH for the serving cell in a DRX group configured with SSSG-DRX-config and searchSpaceGroupIdList according to the search space sets in SSSG #1 (e.g., SSSG 0 as shown in FIG. 4) and stops monitoring PDCCH according to the search space sets in SSSG #2 (e.g., SSSG 1 not shown in FIG. 4) at T4.

For example, the UE may perform operation 432 of Embodiment 3 optimally if at least one of the conditions is met:
if no DCI is detected during a time period of a time offset (e.g., Y-offset) before the start slot of T4 or at/till the start slot that is (at least Y-offset slots/symbols/ms) prior to T4; for example, if no DCI to indicate the UE to start monitoring PDCCH according to SSSG #2 is detected and the drx-onDurationTimer is not running during a time period of a time offset (e.g., Y-offset) before the start slot of T4 or at/till the start slot that is (at least Y-offset slots/symbols/ms) prior to T4; for example, if no DCI in PDCCH reception in the slot for with CRC scrambled by C-RNTI or CS-RNTI or MCS-C-RNTI or SFI-RNTI is detected during a time period of a time offset (e.g., Y-offset) before the start slot of T4 or at/till the start slot that is (at least Y-offset slots/symbols/ms) prior to T4.
if no SR is sent or is pending and the drx-onDurationTimer is not running during a time period of a time offset (e.g., Y-offset) before the start slot of T4 or at/till (the start slot that is at least Y-offset slots/symbols/ms prior to) T4.
if a PDCCH indicating a new transmission addressed to the C-RNTI of the MAC entity has been received and the drx-onDurationTimer is not running during a time period of a time offset (e.g., Y-offset) before the start slot of T4 or at/till the start slot that is (at least Y-offset slots/symbols/ms) prior to T4 after successful reception of a Random Access Response for the Random Access Preamble not selected by the MAC entity among the contention-based Random Access Preamble.
if the MAC entity is not monitoring for a PDCCH transmission on the search space indicated by recoverySearchSpaceId of the serving cell (e.g., SpCell within the DRX group) identified by the C-RNTI (while the ra-ResponseWindow is running) and the drx-onDurationTimer is not running during a time period of a time offset (e.g., Y-offset) before the start slot of T4 or at/till the start slot that is (at least Y-offset slots/symbols/ms) prior to T4.
If both the drx-inactivity timer is not running and the drx-onDurationTimer is not running during a time period of a time offset (e.g., Y-offset) before the start slot of T4 or at the start slot that is (at least Y-offset slots/symbols/ms) prior to T4.

FIG. 5 illustrates an exemplary diagram of applying SSSG in accordance with some embodiments of the present application. In the embodiments of FIG. 5, T1 and T2 are the same as T1 and T2 defined in the embodiments of FIG. 4. In the embodiments of FIG. 5 further define time point T5 as follows:
(1) T5: a start slot that is (at least Y-offset slots/symbols/ms) (e.g., the value of searchSpaceSwitchDelay, which is called P_{switch}) after the last slot or last symbol of the PDCCH with DCI.

FIG. 5 shows “PDCCH monitor occasion in SSSG 0” and “PDCCH monitor occasion in SSSG 1”. In the embodiments of FIG. 5, SSSG 0 is an example of SSSG #1 in the embodiments of FIG. 3, and SSSG 1 is an example of SSSG #2 in the embodiments of FIG. 3. The embodiments of FIG. 5 refer to an example of another SSSG (e.g., SSSG #2) applied according to detected DCI from a network node (e.g., a BS) at T5. Following operations 501 to 503 may be performed in the embodiments of FIG. 5.

In operation 501, a BS may send configuration information regarding SSSG #1 (e.g., SSSG 0 as shown in FIG. 5), configuration information regarding SSSG #2 (e.g., SSSG 1 as shown in FIG. 5), SSSG-DRX-config and DRX-config for a serving cell within a DRX group to a UE in an RRCReconfiguration message. For instance, the UE may receive SSSG-DRX-config and/or searchSpaceGroupIdList in operation 501. Then, the UE may optionally reset PDCCH monitoring according to search space sets with SSSG #1.

In operation 502, the UE may start monitoring PDCCH for the serving cells in a DRX group configured with SSSG-DRX-config and searchSpaceGroupIdList according to the search space sets SSSG #1 (e.g., SSSG 0) and stops monitoring PDCCH according to the search space sets in SSSG #2 (e.g., SSSG 1) at the start slot of On-Duration #1 of the DRX cycle, i.e., T1.

In operation 503, if the UE is provided SSSG-DRX-config for a serving cell, and if the UE detects DCI (e.g., “DCI in SSSG 0 at T5” as shown in FIG. 5) by monitoring PDCCH according to SSSG #1 (e.g., SSSG 0) in the serving cell, the UE may perform operations in following:
The UE starts monitoring PDCCH for the serving cell according to SSSG #2 (e.g., SSSG 1) and stops monitoring PDCCH according to SSSG #1 (e.g., SSSG 0) at the beginning of the start slot that is (at least Y-offset slots/symbols/ms) (e.g., the value of searchSpaceSwitchDelay, which is called P_{switch}) after the last slot or last symbol of the PDCCH with DCI (e.g., T5), wherein the DCI may be used to indicate a new transmission or a retransmission etc., the DCI (which is used to indicate the UE to start monitoring PDCCH according to SSSG #2 (e.g., SSSG 1)) may be detected. Further, the DCI in the PDCCH may be with CRC scrambled by C-RNTI or CS-RNTI or MCS-C-RNTI or SFI-RNTI. And then, the UE may start the searchSpaceSwitchTimer in the SSSG-DRX-config if configured or start the legacy searchSpaceSwitchTimer (of the BWP) of the serving cell; or the UE does not start the searchSpaceSwitchTimer.

In operation 503, in some embodiments, the UE may be bundled to start monitoring the PDCCH transmission if the UE detects DCI “for all the one or more serving cells within the one or more DRX groups” or “for a subset within the one or more serving cells within the one or more DRX groups”. The subset may be configured with SSSG-DRX-config. For instance, the serving cells in a DRX group are bundled for the above search space group switching purpose. The options in different embodiments described above are all applicable for the embodiments of FIG. 5, i.e., Option 1, Option 2, Option 3, and Option 4 in the embodiments of FIG. 3.

In some other embodiments, if the UE is provided SSSG-DRX-config for a serving cell, the UE starts monitoring PDCCH for the serving cell according to SSSG #2 and stops monitoring PDCCH according to SSSG #1 (if the drx-onDurationTimer is running) at one of the time points:
a) At the beginning of the start slot that is (at least Y-offset slots/symbols/ms after) a slot where the UE starts ra-ResponseWindow for monitoring a PDCCH transmission on the search space indicated by recoverySearchSpaceId of the serving cell (e.g., a primary cell (PCell) or a primary and secondary cell (PSCell)) identified by the C-RNTI. For example, recoverySearchSpaceId belongs to SSSG #2 includes recoverySearchSpaceId and the recoverySearchSpaceId does not belong to SSSG #1.
b) At the beginning of the start slot that is (at least Y-offset slots/symbols/ms after) a slot where UE starts the drx-RetransmissionTimerDL. For example, if a MAC PDU is received in a configured downlink assignment and HARQ-NACK for the MAC PDU is transmitted.
c) At the beginning of the start slot that is (at least Y-offset slots/symbols/ms after) a slot where the UE starts the drx-RetransmissionTimerUL. For example, if a MAC PDU is transmitted in a configured uplink grant.
d) At the beginning of the start slot that is (at least Y-offset slots/symbols/ms after) a slot where ra-ContentionResolutionTimer or msgB-ResponseWindow starts.
e) At the beginning of the start slot that is (at least Y-offset slots/symbols/ms after) a slot where a Scheduling Request (SR) is sent on PUCCH.

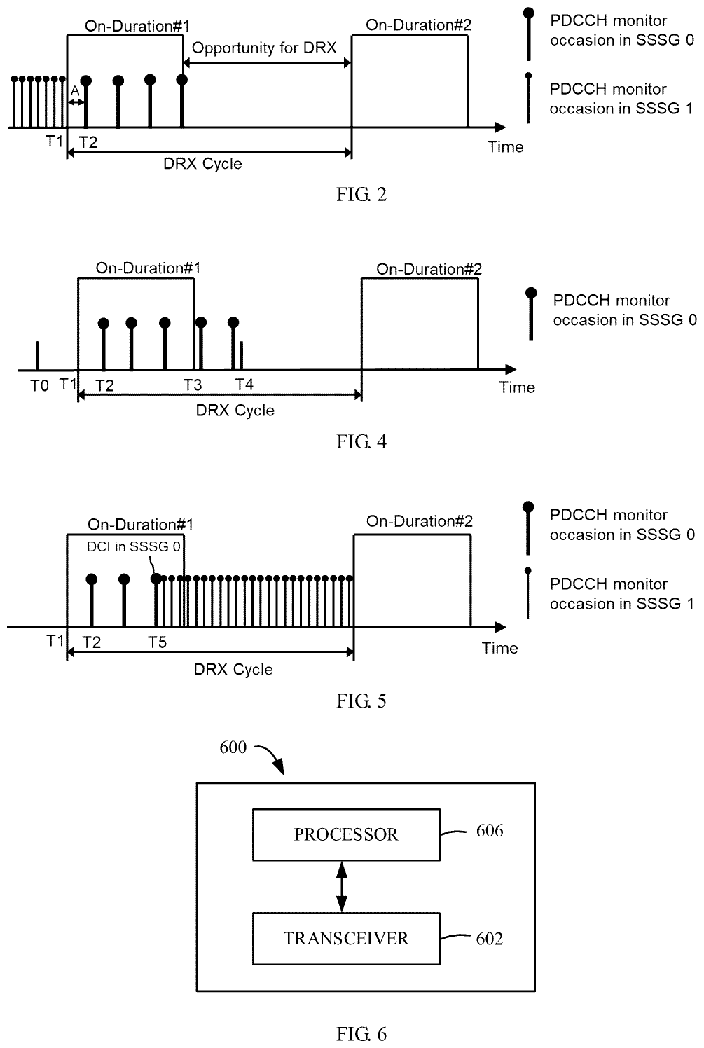

FIG. 6 illustrates a block diagram of an exemplary apparatus 600 in accordance with some embodiments of the present application. As shown in FIG. 6, the apparatus 600 may include at least one processor 606 and at least one transceiver 602 coupled to the processor 606. Although in this figure, elements such as the at least one transceiver 602 and processor 606 are described in the singular, the plural is contemplated unless a limitation to the singular is explicitly stated. In some embodiments of the subject application, the transceiver 602 may be divided into two devices, such as a receiving circuitry and a transmitting circuitry. In some embodiments of the subject application, the apparatus 600 may further include an input device, a memory, and/or other components.

In some embodiments of the subject application, the apparatus 600 may be a UE or a network node (e.g., a BS). The transceiver 602 and the processor 606 may interact with each other so as to perform the operations with respect to the UE or the network node described above, for example, in any of FIGS. 1-5.

In some embodiments of the subject application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to a UE or a network node (e.g., a BS) as described above. For example, the computer-executable instructions, when executed, cause the processor 606 interacting with transceiver 602 to perform the operations with respect to the UE or the network node described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A network node for wireless communication, comprising:
at least one memory; and
at least one processor coupled with the at least one memory and configured to cause the network node to:
transmit first configuration information to a user equipment (UE) for one or more serving cells in one or more discontinuous reception (DRX) groups, wherein the first configuration information includes at least one of:
configuration information regarding a first search space set group (SSSG),
configuration information regarding a second SSSG,
one or more groups of configuration information regarding DRX, or
configuration information of applying SSSG associated with DRX operation of the UE, wherein the configuration information of applying SSSG is used to enable the UE to start monitoring a physical downlink control channel (PDCCH) transmission according to search space sets within the first SSSG at a first time point for the one or more serving cells within the one or more DRX groups.

2. The network node of claim 1, wherein each serving cell within the one or more serving cells is assigned to two or more DRX groups within the one or more DRX groups, and wherein one or more DRX parameters are separately configured for each DRX group within the two or more DRX groups.

3. The network node of claim 1, wherein the first configuration information includes information related to a cell group bundled for SSSG switching, and wherein the serving cells for the SSSG applying in one DRX group within the one or more DRX groups only belong to one cell group bundled for SSSG switching.

4. The network node of claim 1, wherein the configuration information of SSSG applying is configured per a serving cell, per a cell group, per a DRX group, or per a bandwidth part (BWP).

5. The network node of claim 1, wherein the first time point is at least one of:
a start slot of on-duration of a DRX cycle;
a slot after a slot where the UE is in DRX active time only due to a DRX on-duration timer being running;
a slot after a slot where a DRX inactivity timer expires; or
a slot after a last slot where the UE is in the DRX active time.

6. A user equipment (UE) for wireless communication, comprising:
at least one memory; and
at least one processor coupled with the at least one memory and configured to cause the UE to:
receive first configuration information from a network node, wherein the first configuration information includes at least one of: configuration information regarding a first search space set group (SSSG), configuration information regarding a second SSSG, one or more groups of configuration information regarding discontinuous reception (DRX) for one or more serving cells in one or more DRX groups, or configuration information of SSSG applying associated with DRX operation of the UE; and
start monitoring a physical downlink control channel (PDCCH) transmission according to search space sets within the first SSSG at a first time point for the one or more serving cells within the one or more DRX groups based on the configuration information of applying SSSG.

7. The UE of claim 6, wherein the configuration information of applying SSSG is configured per a serving cell, per a cell group, per a DRX group, or per a bandwidth part (BWP).

8. The UE of claim 6, wherein the first time point is at least one of:
a start slot of on-duration of a DRX cycle;
a slot after a slot where the UE is in DRX active time only due to a DRX on-duration timer being running;
a slot after a slot where a DRX inactivity timer expires; or
a slot after a last slot where the UE is in the DRX active time.

9. The UE of claim 6, wherein the at least one processor is further configured to cause the UE to evaluate whether at least one condition for applying SSSG based on the configuration information of applying SSSG is fulfilled at the first time point related to the DRX operation of the UE, and wherein monitoring the PDCCH transmission is started according to the search space sets within the first SSSG at the first time point in response to fulfillment of the at least one condition for applying SSSG at the first time point.

10. The UE of claim 9, wherein the fulfillment of the at least one condition for applying SSSG includes at least one of:
the UE is in DRX active time for the one or more serving cells at a start slot of on-duration of a DRX cycle only due to a DRX on-duration timer being running;
no reception of an indication for indicating the UE to start monitoring the PDCCH transmission according to the second SSSG on the one or more serving cells during a time period of a time offset before a start slot of on-duration of the DRX cycle or till a second time point with the time offset before the start slot of on-duration of the DRX cycle;
no reception of downlink control information (DCI) scrambled by a radio network temporary identification (RNTI) on the one or more serving cells during the time period of the time offset before the start slot of on-duration of the DRX cycle or till the second time point;
a medium access control (MAC) entity being not monitoring the PDCCH transmission on a search space for beam failure recovery of the one or more serving cells during the time period of the time offset before the start slot of on-duration of the DRX cycle or at the start slot of on-duration of the DRX cycle or till the second time point;
at least one of multiple timers including a DRX inactivity timer, a random access (RA) contention resolution timer, a msgB response timer, DRX retransmission timer for downlink, and DRX retransmission timer for uplink of the one or more serving cells being not running during the time period of the time offset before the start slot of on-duration of the DRX cycle or at the start slot of on-duration of the DRX cycle or till the second time point; or
the UE being in DRX inactive time for the one or more serving cells during the time period of the time offset before the start slot of on-duration of the DRX cycle or till the second time point.

11. The UE of claim 6, wherein the at least one processor is further configured to cause the UE to determine a start slot of the search space sets in the first SSSG according to a start slot of on-duration of a DRX cycle for the one or more serving cells.

12. The UE of claim 6, wherein, to start monitoring the PDCCH transmission according to the search space sets in the first SSSG, the at least one processor is further configured to cause the UE to be bundled to start monitoring the PDCCH transmission at the first time point for all the one or more serving cells within the one or more DRX groups or for a subset within the one or more serving cells within the one or more DRX groups, and wherein the subset is configured with the configuration information of applying SSSG.

13. The UE of claim 6, wherein, in response to reception of both information related to a cell group bundled for SSSG switching and the configuration information of applying SSSG in one DRX group within the one or more DRX groups, the at least one processor is further configured to cause the UE to ignore information related to the cell group for SSSG switching including two or more serving cells with the configuration information of applying SSSG.

14. The UE of claim 6, wherein each serving cell within the one or more serving cells is assigned to two or more DRX groups within the one or more DRX groups, and wherein one or more DRX parameters are separately configured for each DRX group within the two or more DRX groups.

15. A method performed by a user equipment (UE), the method comprising:
receiving first configuration information from a network node, wherein the first configuration information includes at least one of: configuration information regarding a first search space set group (SSSG), configuration information regarding a second SSSG, one or more groups of configuration information regarding discontinuous reception (DRX) for one or more serving cells in one or more DRX groups, or configuration information of applying SSSG associated with DRX operation of the UE; and
starting a monitoring of a physical downlink control channel (PDCCH) transmission according to search space sets within the first SSSG at a first time point for the one or more serving cells within the one or more DRX groups based on the configuration information of applying SSSG.

16. The method of claim 15, wherein the configuration information of applying SSSG is configured per a serving cell, per a cell group, per a DRX group, or per a bandwidth part (BWP).

17. The method of claim 15, wherein the first time point is at least one of:
a start slot of on-duration of a DRX cycle;
a slot after a slot where the UE is in DRX active time only due to a DRX on-duration timer being running;
a slot after a slot where a DRX inactivity timer expires; or
a slot after a last slot where the UE is in the DRX active time.

18. The method of claim 15, further comprising: evaluating whether at least one condition for applying SSSG based on the configuration information of applying SSSG is fulfilled at the first time point related to the DRX operation of the UE, and wherein monitoring the PDCCH transmission is started according to the search space sets within the first SSSG at the first time point in response to fulfillment of the at least one condition for applying SSSG at the first time point.

19. A method performed by a network node, the method comprising:
transmitting first configuration information to a user equipment (UE) for one or more serving cells in one or more discontinuous reception (DRX) groups, wherein the first configuration information includes at least one of:
configuration information regarding a first search space set group (SSSG),
configuration information regarding a second SSSG,
one or more groups of configuration information regarding DRX, or
configuration information of applying SSSG associated with DRX operation of the UE, wherein the configuration information of applying SSSG is used to enable the UE to start monitoring a physical downlink control channel (PDCCH) transmission according to search space sets within the first SSSG at a first time point for the one or more serving cells within the one or more DRX groups.

20. The method of claim 19, wherein each serving cell within the one or more serving cells is assigned to two or more DRX groups within the one or more DRX groups, and wherein one or more DRX parameters are separately configured for each DRX group within the two or more DRX groups.
